(19) United States
(12) Patent Application Publication
(10) Pub. No.: US 2016/0011875 A1
(43) Pub. Date: Jan. 14, 2016

(54) UNDEFINED INSTRUCTION RECODING

(71) Applicant: Apple Inc., Cupertino, CA (US)

(72) Inventor: Shyam Sundar, Sunnyvale, CA (US)

(21) Appl. No.: 14/325,981

(22) Filed: Jul. 8, 2014

(51) Int. Cl. G06F 9/38; G06F 12/08

(52) U.S. Cl. CPC G06F 9/3808; G06F 12/0875; G06F 2212/452

(57) ABSTRACT

A system and method for efficiently decoding and handling undefined instructions. A semiconductor chip predecodes instructions of a computer program. In response to determining a particular instruction is an undefined operation, the chip replaces an N-bit opcode in the particular instruction with an N-bit pattern different from the opcode. When instructions are fetched from an instruction cache, the corresponding opcodes are compared to the N-bit pattern. When a match is found, a trap may be set. The trap may later cause an exception handler subroutine for undefined operations to initiate execution.

### BACKGROUND

1. Technical Field

Embodiments described herein relate to computing systems, and more particularly, to efficiently decoding undefined instructions.

2. Description of the Relevant Art

With each generation, semiconductor chips provide more functionality and performance. For example, the semiconductor chips include overlapping pipeline stages, out-of-order and speculative execution of instructions, simultaneous multi-threading, and so forth. During each clock cycle, the semiconductor chip ideally produces useful processing of a maximum number of instructions. However, exceptions may occur. In response to detecting an exception, a trap may be set, such as asserting a flag value in a register, in order to later initiate an exception handling subroutine. The semiconductor chip temporarily suspends one or more processes and begins executing the exception handling subroutine.

One example of an exception is detection of an undefined operation for a particular instruction. Control logic within the semiconductor chip may inspect an opcode within the particular instruction. In addition, the control logic may inspect one or more bits of information in a status field corresponding to the particular instruction. When the inspected information is decoded and does not yield a supported operation, the particular instruction is an undefined operation. An indication of the undefined operation may be stored.

Typically, the semiconductor chips include two or three levels of cache hierarchy for supplying instructions and data to one or more processing units. The semiconductor chip may be a microprocessor and each of the one or more processing units is a processor core. Alternatively, the semiconductor chip may be a system-on-a-chip (SOC) and the one or more processing units are a central processing unit (CPU), a graphics processing unit (GPU), or another data processing unit. The undefined operation flag may be stored for each instruction in a cache block within each of the two or three levels of cache hierarchy. Therefore, an appreciable amount of on-die real estate is used for indicating undefined operations.

Alternatively, the undefined operation flag may be stored for associated instructions in an array separate from the cache hierarchy. The array may be accessed simultaneously with an access of the first level cache. If the array is undersized, then additional undefined instructions may not be detected until late in a decode pipeline stage. On-die real estate is used for the separate array as well as additional power is consumed for accessing the array simultaneously with accesses of the first level cache.

In view of the above, efficient methods and mechanisms for efficiently decoding undefined instructions are desired.

### BRIEF SUMMARY

Systems and methods for efficiently decoding and handling undefined instructions are contemplated. In one embodiment, a semiconductor chip receives instructions of a computer program from off-die memory. In response to determining a particular instruction of the received instructions is an undefined operation, the chip replaces an N-bit opcode in the particular instruction with one or more bits different from the opcode. Following, the chip stores the instructions in an instruction cache. An indication the particular instruction stored in the instruction cache is an undefined operation is wholly represented by the N-bit pattern comprised within the particular instruction. No other field in the instruction cache may indicate the particular instruction is an undefined operation.

When one or more instructions are fetched from the instruction cache, the corresponding opcodes are compared to the N-bit pattern. When a match is found, a trap may be set. The trap may later cause an exception handler subroutine for undefined operations to initiate execution.

These and other embodiments will be further appreciated upon reference to the following description and drawings.

### BRIEF DESCRIPTION OF THE DRAWINGS

FIG. 1 is a generalized block diagram of one embodiment of a processor.

FIG. 2 is a generalized block diagram of one embodiment of an exemplary cache.

FIG. 3 is a generalized flow diagram illustrating one embodiment of a method for recoding undefined instructions.

FIG. 4 is a generalized flow diagram illustrating one embodiment of a method for decoding and handling undefined instructions.

While embodiments described in this disclosure may be susceptible to various modifications and alternative forms, specific embodiments thereof are shown by way of example in the drawings and will herein be described in detail. It should be understood, however, that the drawings and detailed description thereto are not intended to be limiting to the particular form disclosed, but on the contrary, the intention is to cover all modifications, equivalents and alternatives falling within the spirit and scope of the appended claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112(f) for that unit/circuit/component.

### DETAILED DESCRIPTION

In the following description, numerous specific details are set forth to provide a thorough understanding of the described embodiments. However, one having ordinary skill in the art should recognize that the embodiments might be practiced without these specific details. In some instances, well-known circuits, structures, and techniques have not been shown in detail to avoid obscuring certain details of the embodiments.

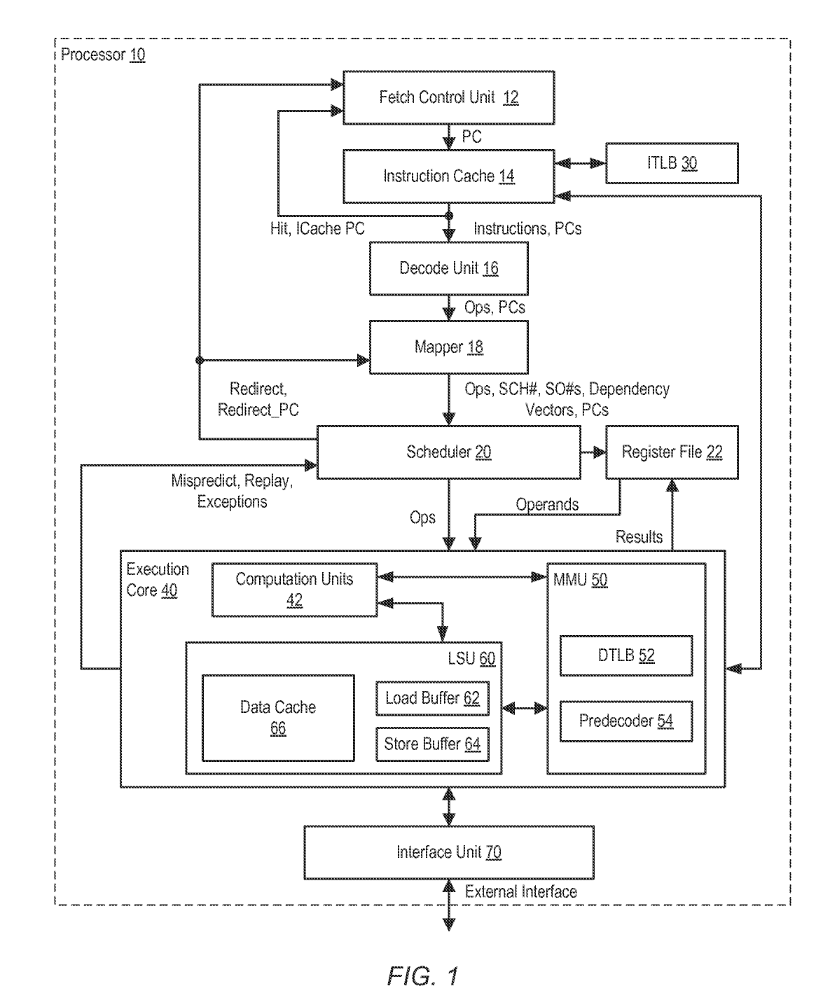

Referring to FIG. 1, a generalized block diagram illustrating one embodiment of a processor 10 is shown. In the illustrated embodiment, the processor 10 includes a fetch control unit 12, an instruction cache 14, a decode unit 16, a mapper 18, a scheduler 20, a register file 22, an execution core 40, and an interface unit 70. The fetch control unit 12 is coupled to provide a program counter address (PC) for fetching from the instruction cache 14. The instruction cache 14 is coupled to provide instructions (with PCs) to the decode unit 16, which is coupled to provide decoded instruction operations (ops, again with PCs) to the mapper 18. The instruction cache 14 is further configured to provide a hit indication and an instruction cache (i-cache) PC to the fetch control unit 12.

Fetch control unit 12 may be configured to generate fetch PCs for instruction cache 14. In some embodiments, fetch control unit 12 may include one or more types of branch predictors. When generating a fetch PC, in the absence of a non-sequential branch target and depending on how many bytes are fetched from instruction cache 14 at a given time, fetch control unit 12 may generate a sequential fetch PC by adding a known offset to a current PC value.

The instruction cache 14 may be a cache memory for storing instructions to be executed by the processor 10. The instruction cache 14 may have any capacity and construction (e.g. direct mapped, set associative, fully associative, etc.). The instruction cache 14 may have any cache line size. For example, 64 byte cache lines may be implemented in an embodiment. Other embodiments may use larger or smaller cache line sizes. In response to a given PC from the fetch control unit 12, the instruction cache 14 may output up to a maximum number of instructions. It is contemplated that processor 10 may implement any suitable instruction set architecture (ISA), such as, e.g., the ARM™, PowerPC™, or x86 ISAs, or combinations thereof.

Processor 10 may implement an address translation scheme in which one or more virtual address spaces are made visible to executing software. Memory accesses within the virtual address space are translated to a physical address space corresponding to the actual physical memory available to the system, for example using a set of page tables, segments, or other virtual memory translation schemes. In embodiments of processor 10 that employ address translation, the i-cache 14 may be partially or completely addressed using physical address bits rather than virtual address bits. For example, i-cache 14 may use virtual address bits for cache indexing and physical address bits for cache tags.

In order to avoid the cost of performing a full memory translation when performing a cache access, processor 10 may store a set of recent and/or frequently used virtual-to-physical address translations in a translation lookaside buffer (TLB), such as Instruction TLB (ITLB) 30. During operation, ITLB 30 may receive virtual address information and determine whether a valid translation is present. If so, ITLB 30 may provide the corresponding physical address bits to i-cache 14. If not, ITLB 30 may cause the translation to be determined, for example by raising a virtual memory exception.

The operating system may instruct the processor 10 to execute a particular thread of a process. The operating system may provide an address or a pointer to the start of the instructions of the particular thread stored in off-die memory. The interface unit 70 may be used to retrieve the instructions in off-die memory and send them to the i-cache 14. Control logic in the processor 10 may perform predecoding of the received instructions. The predecoding may determine at least whether the received instructions correspond to undefined operations.

When the control logic in the processor 10 determines a received particular instruction is an undefined operation, the N-bit opcode of the particular instruction is replaced with an N-bit pattern different from the opcode prior to storing the particular instruction in the i-cache 14. The N-bit pattern may also correspond to an undefined operation, but also indicate an undefined operation to logic within at least the decode unit 16. In various embodiments, the N-bit pattern corresponds to a predetermined pattern. Alternatively, the pattern is programmable. In one example, the N-bit pattern is a series of N zeroes. The decode unit 16 may include zero detect logic to determine in a later clock cycle whether a fetched instruction from the i-cache 14 is an undefined operation.

Storing the N-bit pattern in the i-cache 14 in place of the N-bit opcode for the particular instruction allows for the removal of any storage of an additional flag value in the i-cache 14 indicating an undefined instruction. Similarly, the storage of the N-bit pattern allows for the removal of any separate array that stores information of undefined instructions. Therefore, on-die real estate is reduced. An indication the particular instruction stored in the i-cache 14 is an undefined operation may be wholly represented by the N-bit pattern comprised within the particular instruction.

In the above example, an N-bit opcode and an N-bit pattern were used. For instructions with a variable-sized opcode, different size patterns may be used. For example, an M-bit opcode of a particular instruction that is determined to be undefined is replaced with an M-bit pattern different from the opcode prior to storing the particular instruction in the i-cache 14. Here, M is an integer different from the integer N. An indication the particular instruction stored in the i-cache 14 is an undefined operation may be wholly represented by the M-bit pattern comprised within the particular instruction.

The decode unit 16 may generally be configured to decode received instructions into instruction operations (ops). Generally, an instruction operation may be an operation that the hardware included in the execution core 40 is capable of executing. Each instruction may translate to one or more instruction operations which, when executed, result in the operation(s) defined for that instruction being performed according to the instruction set architecture implemented by the processor 10.

In some embodiments, each instruction may decode into a single instruction operation. The decode unit 16 may be configured to identify the type of instruction, source and destination operands, etc., and the decoded instruction operation may include the instruction along with some of the decode information. In other embodiments in which each instruction translates to a single op, each op may simply be the corresponding instruction or a portion thereof (e.g. the opcode field or fields of the instruction).

The decode unit 16 may determine a fetched instruction corresponds to an undefined operation. For example, the decode unit 16 may compare the opcode of a fetched particular instruction to the N-bit pattern, which indicates an undefined operation. In the case the N-bit pattern is a series of N zeroes, the decode unit 16 may utilize zero detect logic for the opcode.

The decode unit 16 may also determine the size of the opcode when the instructions utilize variable-sized opcodes. The decode unit 16 may determine the proper size pattern for the opcode prior to any comparisons of the opcodes to patterns. The decode unit 16 may compare the opcode to an M-bit pattern for instructions with an M-bit opcode, wherein M is different than N. The M-bit pattern may have been placed in the instruction during predecoding as described earlier. When the M-bit opcode matches the M-bit pattern, the fetched particular instruction is an undefined operation. In response to determining the fetched particular instruction is an undefined operation, the decode unit 16 may set a corresponding trap. A particular trap register or a particular field within a trap register may be asserted. The stored indication of the trap may initiate an exception handling subroutine corresponding to undefined operations.

When an instruction is not determined to be an undefined operation, typical processing is performed on the instruction. Ops generated by the decode unit 16 may be provided to the mapper 18. The mapper 18 is coupled to provide ops, a scheduler number (SCH#), source operand numbers (SO#s), one or more dependency vectors, and PCs to the scheduler 20. The mapper 18 may implement register renaming to map source register addresses from the ops to the source operand numbers (SO#s) identifying the renamed source registers.

The scheduler 20 is coupled to receive replay, mispredict, and exception indications from the execution core 40, is coupled to provide a redirect indication and redirect PC to the fetch control unit 12 and the mapper 18, is coupled to the register file 22, and is coupled to provide ops for execution to the execution core 40. The scheduler 20 may be configured to store the ops in the scheduler entries identified by the respective SCH#s, along with the SO#s and PCs. The scheduler 20 may be configured to schedule the ops for execution in the execution core 40.

When an op is scheduled, the scheduler 20 may be configured to read its source operands from the register file 22 and the source operands may be provided to the execution core 40. The execution core 40 may be configured to return the results of ops that update registers to the register file 22. In some cases, the execution core 40 may forward a result that is to be written to the register file 22 in place of the value read from the register file 22 (e.g. in the case of back to back scheduling of dependent ops).

The execution core 40 includes computation units 42 for executing received ops according to associated opcodes. Examples of operations to execute include integer and floating-point arithmetic operations. The execution core 40 may also include a load store unit (LSU) 60 for handling memory access operations. The memory access operations may include various types of integer and floating-point load and store operations.

The LSU 60 may include a load buffer 62, a store buffer 64 and a data cache 66. The load buffer 62 may store address information for load operations that have not yet committed when the load buffer 62 receives the data from a data cache, the store buffer 64, or a lower-level memory. The store buffer 64 may store address and data information for store operations that have committed, in order to facilitate load dependency checking.

The execution core 40 may include a data cache 66, which may be a cache memory for storing data to be processed by the processor 10. One or more levels of a data cache may be used. For example, the LSU 60 may include a level-one (L1) data cache (not shown) and the L2 data cache 66. A L3 data cache or other lower-level memory may be located off-die. Other combinations for a memory hierarchy are possible and contemplated. Like the i-cache 14, the data cache 66 may have any suitable capacity, construction, or line size (e.g. direct mapped, set associative, fully associative, etc.). Moreover, the data cache 66 may differ from the instruction cache 14 in any of these details. The data cache 66 may store recently accessed data.

As with the instruction cache 14, in some embodiments, the data cache 66 may be partially or entirely addressed using physical address bits. Correspondingly, a data TLB (DTLB) 52 within the memory management unit (MMU) 50 may be provided to store virtual-to-physical address translations for use in accessing the data cache 66. A virtual address space for the data stored in system memory and used by a software process may be divided into pages of a prefixed size.

The MMU 50 may also include a predecoder 54 for predecoding instructions retrieved from off-die memory. In various embodiments, the control logic described earlier for detecting undefined operations and replacing opcodes with a particular pattern may be located within the predecoder 54. In other embodiments, the control logic may be located within a cache controller for the i-cache 14. In yet other embodiments, the control logic may be located elsewhere in the processor 10.

The execution core 40 is coupled to the interface unit 70, which is further coupled to one or more external interfaces of the processor 10. The interface unit 70 may generally include the circuitry for interfacing the processor 10 to other devices on the external interface. The external interface may include any type of interconnect (e.g. bus, packet, etc.). The external interface may be an on-chip interconnect, if the processor 10 is integrated with one or more other components (e.g. a system on a chip configuration). The external interface may be on off-chip interconnect to external circuitry, if the processor 10 is not integrated with other components. The MMU 50 and the interface 70 may be used to retrieve instructions of a computer program from off-die memory. The received instructions may be predecoded by the predecoder 54 as described earlier. After predecoding, the instructions are stored in the i-cache 14.

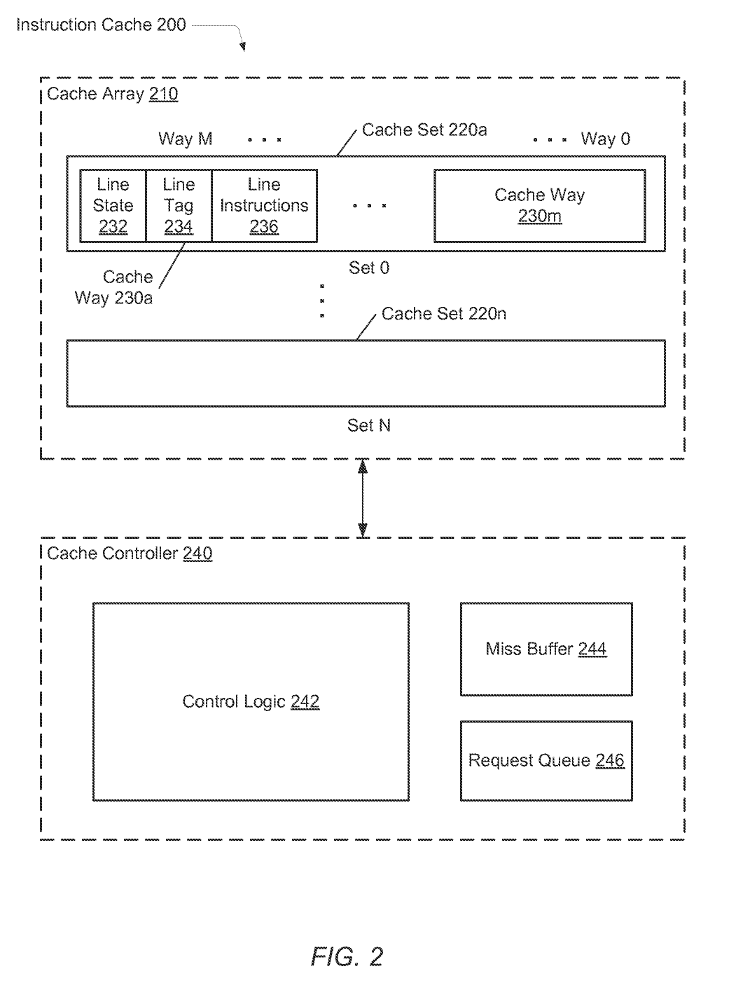

Turning now to FIG. 2, a generalized block diagram of one embodiment of an exemplary instruction cache 200 is shown. As shown in the illustrated embodiment, the instruction cache 200 includes a cache array 210 and a cache controller 240. Generally, the cache array 210 may store one or more cache lines, each of which is a copy of one or more instructions stored at a corresponding address in the system memory. As used herein, a “line” is a set of bytes stored in contiguous memory locations, which are treated as a unit for coherency purposes. As used herein, the terms “cache block”, “block”, “cache line”, and “line” are interchangeable. In some embodiments, a line may also be the unit of allocation and deallocation in a cache. The number of bytes in a line may be varied according to design choice, and may be of any size. As an example, 32 byte and 64 byte lines are often used.

The cache array 210 may store data in various manners. For example, data may be stored in the cache array 210 using a set-associative cache organization. An M-way set associativity is shown in the illustrated embodiment, wherein M is an integer. Each one of the cache sets 220a-220n includes cache ways 230a-230m. A different number of ways, such as 4-way, 8-way, 16-way, or other, within the set-associative cache array 210 may be chosen. In various embodiments, each one of the cache sets 220a-220n utilizes the chosen storage manner, such as set associativity.

Each one of the cache ways 230a-230m may include a line state 232, a line tag 234, and a line instruction 236. Each of the line state 232, line tag 234, and the line instruction 236 is data stored in the instruction cache 200. Although line state 232 and line tag 234 may be stored in contiguous bits with the line instruction 236 within each one of the cache ways 230a-230m, in other embodiments, the line state 232 and the line tag 234 may be stored in a separate array, rather than in a same array as the line instruction 236.

The line state 232 may comprise at least one or more of the following: a valid bit, a cache line owner encoding that indicates the source which owns the corresponding cache line, Least Recently Used (LRU) eviction information used in association with a cache replacement algorithm employed by the cache controller 240, an indication that designates a cache coherency state, a privilege or security state, and so forth. Other included state information is possible and contemplated.

A given one of the cache sets 220a-220n may be selected from other sets by a line index portion of an address used to access the cache 200. A cache line hit may occur when a combination of a portion of the line state 232 and the line tag 234 match values from an access request. In addition, an offset in the address of the access request may be used to indicate a specific byte or word within a cache line.

The cache controller 240 may include at least control logic 242, a miss buffer 244 and a request queue 246. Memory access requests may be stored in the request queue 246. A cache miss may cause request information to be stored in the miss buffer 244. The information stored in the miss buffer 244 may be used later to send requests to a lower level of the cache hierarchy. Generally, the control logic 242 may determine a manner used to order accesses of the cache array 210 and perform updates to state, address and instruction data stored in the cache array 210.

Each one of the line instructions 236 stores an opcode. Prior to storing an instruction in one of the line instructions 236 in the instruction cache 200, the opcode may have been replaced with a pattern during instruction predecoding. The replacement may occur as described earlier. In some embodiments, the conditional replacement of an N-bit opcode with an N-bit pattern occurs in control logic within a memory management unit. In other embodiments, the conditional replacement of the N-bit opcode with an N-bit pattern occurs in the control logic 242 within the cache controller 240 of the instruction cache 200. In yet other embodiments, the conditional replacement of the N-bit opcode with an N-bit pattern occurs in control logic placed elsewhere in the corresponding semiconductor chip. In yet other embodiments, the conditional replacement may occur for other sizes of opcodes and patterns. For example, an M-bit opcode may be conditionally replaced with an M-bit pattern, wherein M is different from N.

For an undefined instruction stored in one of the line instructions 236, the pattern that replaced the opcode may indicate the instruction is undefined. An indication that the particular instruction stored in the cache array 210 is an undefined operation may be wholly represented by the pattern comprised within the instruction. Information stored in a corresponding one of the line states 232 may not store an indication of an undefined instruction. The line state 232 may store a valid bit to indicate whether the instruction is valid, such as the instruction is not evicted or unallocated. However, the valid bit may not indicate an instruction is undefined.

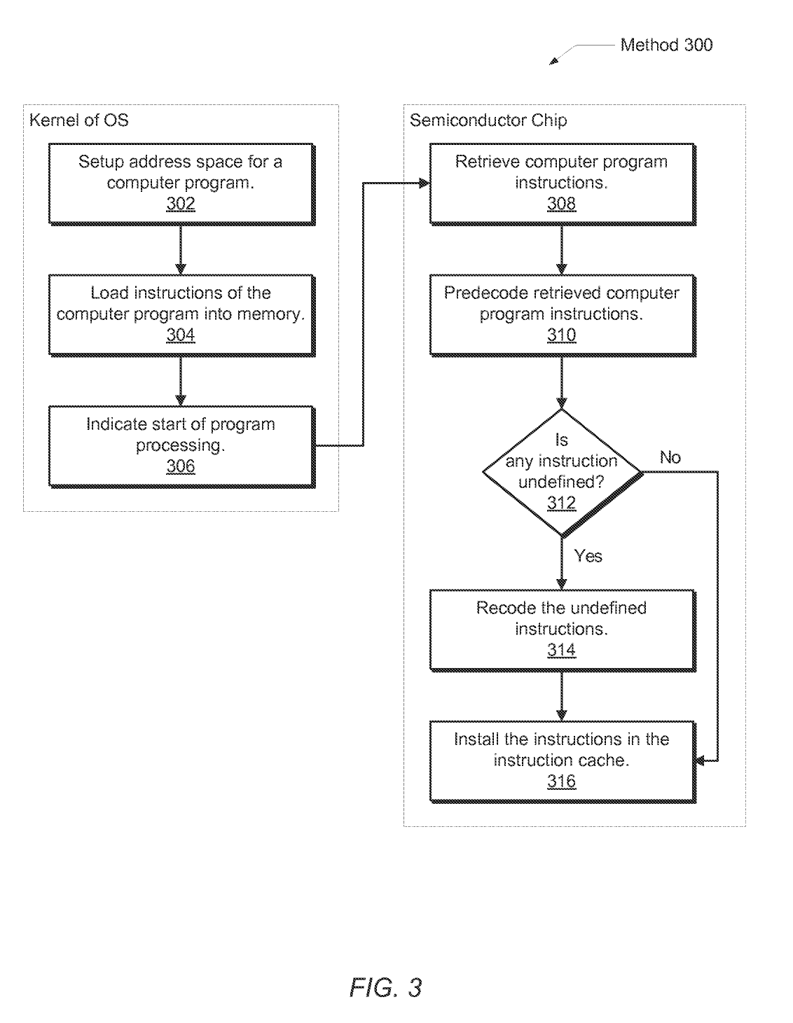

Turning now to FIG. 3, a generalized flow diagram of one embodiment of a method 300 for recoding undefined instructions is shown. Method 300 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment.

Generally speaking, software programmers write applications to perform work according to an algorithm or a method. A disk memory may store an operating system (OS) for a computer system. For a given software application, in block 302, the kernel of the OS sets up an address space for the application. The address space may be a contiguous virtual address space, wherein a mapping between virtual addresses and physical addresses determines the location of values in physical memory, such as disk memory and DRAM. The given ISA for a corresponding semiconductor chip may be used to select a manner for declaring and allocating regions of memory.

The software application may be stored in one or more of a disk memory, a dynamic random access memory (DRAM), dual in-line memory modules (dimms), and a peripheral device. If the software application is not already located in the disk memory, then in block 304, the kernel of the OS loads the application's code into the disk memory. The instructions of the software application may also be loaded into DRAM or dimms. The kernel may also set up a stack for the application.

When the OS determines the software application or computer program can begin processing, in block 306, an indication to start processing the instructions is asserted. In response, the kernel instructs a corresponding semiconductor chip to branch to a given location inside the application code and begin instruction processing. In some embodiments, not all of the instructions and the data need to be stored in physical memory before execution begins. In various embodiments, the semiconductor chip is a microprocessor. In other embodiments, the semiconductor chip is a SOC, a GPU, or other processing unit.

In block 308, the semiconductor chip retrieves the instructions of the software application. The chip may send requests for instructions based on the given location provided by the kernel. The instructions may be retrieved from DRAM, dimms, or disk memory. In block 310, the retrieved instructions are predecoded by the chip. In some embodiments, control logic within a memory controller or a memory management unit predecodes the received instructions. In other embodiments, the control logic for predecoding the received instructions is located in a cache controller or elsewhere in the chip.

The predecoding of the received instructions may determine whether one or more of the received instructions are an undefined operation. There may be many causes for an instruction to be undefined. For example, with each generation, semiconductor chips provide more functionality and performance. On-die geometric dimensions continue to reduce which contributes to the increased functionality and performance. However, these advancements may also create design issues that limit the potential benefits. With both the node capacitance and the supply voltage decreasing over time with the next generations of new processors, the amount of electrical charge stored on a node decreases. Due to this fact, nodes are more susceptible to radiation induced soft errors caused by high-energy particles such as cosmic rays, alpha particles, and neutrons. This radiation creates minority carriers at the source and drain regions of transistors to be transported by the source and drain diodes. The change in charge stored on a node compared to the total charge, which is decreasing with each generation, may be a large enough percentage that it surpasses the circuit's noise margin and alters the stored state of the node. Although the circuit is not permanently damaged by this radiation, a logic failure may occur.

A significant change in charge on the reduced node sizes may also be caused by capacitative cross coupling noise of nearby metal traces. The corrupted data may include an opcode of a particular instruction. The opcode of the particular instruction may be erroneously set to indicate an undefined operation. Fabrication steps of the semiconductor chips and accompanying components coupled to the chips may inadvertently cause stuck-at faults. The stuck-at faults may corrupt an opcode of an instruction by the time the instruction is received by predecode logic in the semiconductor chip. Although a semiconductor chip and accompanying components may have been previously tested to meet predetermined quality requirements, as with the software application, testing under all combinations of inputs and preconditions, such as an initial state, is not feasible. Therefore, a functional error may cause a corrupted opcode to be presented to the predecode control logic.

In addition to reduced on-die geometric dimensions, algorithm development has advanced to provide more functionality and performance. In order to support the advanced algorithms, some instruction set architectures (ISAs) are extended by implementing new instructions. However, these new instructions may be processed by a coprocessor, rather than the semiconductor chip. If the coprocessor is not enabled, the new instruction is an undefined operation. Privilege and security states may cause undefined operations. For example, an instruction indicating a write access to a read-only register or region of memory may be determined to be an undefined operation.

A NOP (no operation) instruction may be considered to be a defined operation. The NOP instruction may increment the register storing the program counter (PC) to point to the next instruction, but affects nothing else. If the predecode logic in the semiconductor chip determines any instruction of the received instructions is undefined (conditional block 312), then in block 314, the undefined instructions are recoded. For example, an N-bit opcode for the undefined instructions may be replaced with an N-bit pattern different from the opcode prior to storing the particular instruction in an instruction cache.

The N-bit pattern may also correspond to an undefined operation, but also indicate an undefined operation to logic within at least decode logic. In one example, the N-bit pattern is a series of N zeroes. The decode logic may include zero detect logic to determine at a later time whether a fetched instruction from the instruction cache is an undefined operation. An indication the particular instruction stored in the instruction cache is an undefined operation may be wholly represented by the N-bit pattern comprised within the particular instruction.

For instructions with a variable-sized opcode, different size patterns may be used. For example, an M-bit opcode of a particular instruction that is determined to be undefined is replaced with an M-bit pattern different from the opcode prior to storing the particular instruction in the instruction cache. Here, M is an integer different from the integer N. In block 316, the received instructions are stored or installed in the instruction cache. The instructions determined to be undefined are stored with the appropriate pattern replacing the opcode.

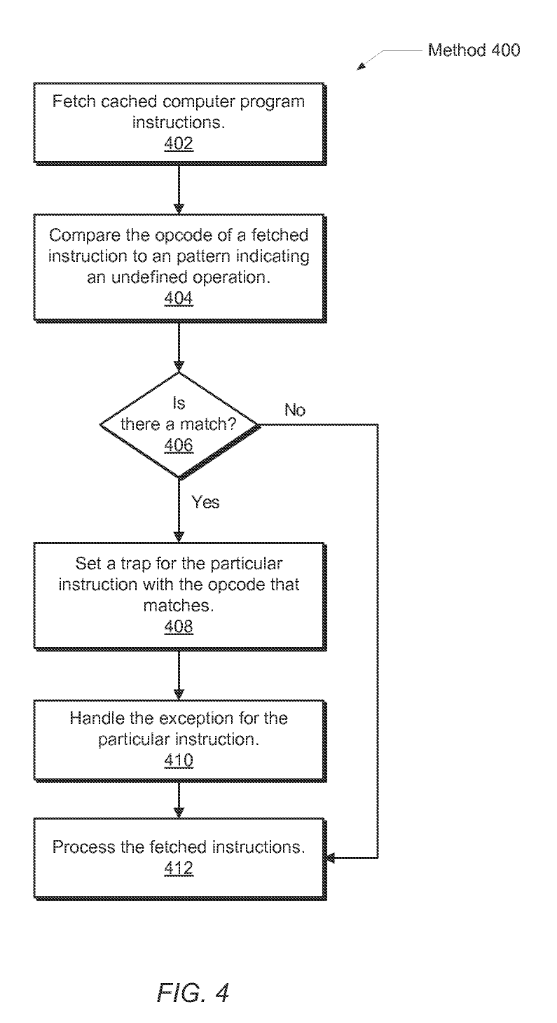

Turning now to FIG. 4, a generalized flow diagram of one embodiment of a method 400 for decoding and handling undefined instructions is shown. Method 400 may be modified by those skilled in the art in order to derive alternative embodiments. Also, the steps in this embodiment are shown in sequential order. However, some steps may occur in a different order than shown, some steps may be performed concurrently, some steps may be combined with other steps, and some steps may be absent in another embodiment.

In the embodiment shown, instructions of a computer program are fetched in block 402. The opcode of a fetched instruction is compared to a pattern indicating an undefined operation in block 404. For example, if the pattern is a series of bits that are all zeroes, instruction decode logic may include zero detect logic. In other examples, a different pattern is selected and different comparison logic is used within the instruction decode logic.

If there is a match (conditional block 406), then in block 408, a trap is set for the particular instruction with the opcode that matches. A given register corresponding to the trap may be written with a given flag value. Information corresponding to the particular instruction may also be stored, such as at least the PC, the operands, a process or a thread identifier (ID), an owner ID and so on.

In block 410, an exception corresponding to the undefined instruction is handled by a subroutine. The exception handler subroutine may cause the semiconductor chip to temporarily suspend one or more processes and then begin executing the subroutine. In some examples, the exception handler subroutine may be used to emulate coprocessor functionality in software. In other examples, the subroutine reloads the undefined instruction that caused the trap. In yet other examples, the subroutine reports an error and ceases program execution. Other subroutine steps are possible and contemplated. In block 412, the fetched instructions are processed. If an exception handler subroutine ceases program execution, then the fetched instructions remain in the semiconductor chip until the OS provides further steps to take. If the exception handler subroutine removes the suspension of processes, then the fetched instructions are processed.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
an instruction cache (i-cache) configured to store a plurality of instructions; and
control logic configured to:
receive a first instruction;
in response to determining that the first instruction corresponds to an undefined operation, replace an opcode of the first instruction with one or more bits different from the opcode; and
store the first instruction with the replaced opcode in the i-cache.

2. The processor as recited in claim 1, wherein an indication the first instruction stored in the i-cache is an undefined operation is represented by the one or more bits different from the opcode within the first instruction.

3. The processor as recited in claim 1, wherein the control logic is further configured to:
fetch a second instruction from the i-cache; and
determine if an opcode of a second instruction corresponds to an undefined operation.

4. The processor as recited in claim 3, wherein determining the opcode of the second instruction corresponds to an undefined operation comprises determining the opcode of the second instructions matches the one or more bits.

5. The processor as recited in claim 1, wherein the one or more bits consist of a number of bits that varies in dependence on a size of the opcode.

6. The processor as recited in claim 1, wherein to determine the first instruction corresponds to an undefined operation, the control logic is configured to determine the opcode of the first instruction corresponds to an operation to be performed by a coprocessor that is disabled.

7. The processor as recited in claim 2, wherein to determine the first instruction corresponds to an undefined operation, the control logic is configured to determine the opcode of the first instruction corresponds to an operation that writes to a read-only register or read-only region of memory.

8. A method comprising:
receiving a first instruction;
in response to determining that the first instruction corresponds to an undefined operation, replacing an opcode of the first instruction with one or more bits different from the opcode; and
storing the first instruction with the replaced opcode in an instruction cache (i-cache).

9. The method as recited in claim 8, wherein an indication the first instruction stored in the i-cache is an undefined operation is represented by the one or more bits different from the opcode within the first instruction.

10. The method as recited in claim 9, further comprising:
fetching a second instruction from the i-cache; and
determining if an opcode of a second instruction corresponds to an undefined operation.

11. The method as recited in claim 10, wherein determining the opcode of the second instruction corresponds to an undefined operation comprises determining the opcode of the second instruction matches the one or more bits.

12. The method as recited in claim 8, wherein the one or more bits consist of a number of bits that varies in dependence on a size of the opcode.

13. The method as recited in claim 8, wherein to determine the first instruction corresponds to an undefined operation, the method comprises determining the opcode of the first instruction corresponds to an operation to be performed by a coprocessor that is disabled.

14. The method as recited in claim 9, wherein to determine the first instruction corresponds to an undefined operation, the method comprises determining the opcode of the first instruction corresponds to an operation that writes to a read-only register or read-only region of memory.

15. The method as recited in claim 8, wherein one or more bits comprise a predetermined pattern.

16. The method as recited in claim 15, wherein the predetermined pattern is programmable.

17. A non-transitory computer readable storage medium storing program instructions, wherein the program instructions are executable to:
receive a first instruction;
in response to determining that the first instruction corresponds to an undefined operation, replace an opcode of the first instruction with one or more bits different from the opcode; and
store the first instruction with the replaced opcode in an instruction cache (i-cache).

18. The non-transitory computer readable storage medium as recited in claim 15, wherein an indication the first instruction stored in the i-cache is an undefined operation is represented by the one or more bits different from the opcode within the first instruction.

19. The non-transitory computer readable storage medium as recited in claim 16, wherein the program instructions are further executable to:
fetch a second instruction from the i-cache; and
determine if an opcode of a second instruction corresponds to one or more bits which indicate an undefined operation.

20. The non-transitory computer readable storage medium as recited in claim 17, wherein determining the opcode of the second instruction corresponds to an undefined operation comprises determining the opcode of the second instruction matches the one or more bits.
